(19) United States
(12) Patent Application Publication
(10) Pub. No.: US 2026/0014961 A1
(43) Pub. Date: Jan. 15, 2026

(54) EXTERNALLY MOUNTED WIPER SYSTEM FOR ROTATING HEAT EXCHANGE/DRYER

(71) Applicant: The Dupps Company, Germantown, OH (US)

(72) Inventors: Douglas R. TIMES, Miamisburg, OH (US); Adam C. DOWNEY, Beavercreek, OH (US)

(21) Appl. No.: 18/768,744

(22) Filed: Jul. 10, 2024

(51) Int. Cl. B60S 1/38

(52) U.S. Cl. CPC B60S 1/3801; B60S 2001/3829

(57) ABSTRACT

A rotating disc heat exchanger includes a shell defining an internal space for heat treating material via a plurality of rotatable discs located therein. A wiper includes a mount portion located outside of the internal space and a wiping portion that is located within the internal space. The shell includes a shell opening through which the at least one wiper extends. The mount portion includes a mount arrangement that is configured to enable: (i) adjustment of a position of the at least one wiper along a width of the shell opening; and/or (ii) removal and replacement of the at least one wiper from a location externally of the shell; and/or (iii) pivot of the at least one wiper about a pivot axis located externally of the shell, at least upon shear of a shear pin associated with the mount arrangement.

### TECHNICAL FIELD

The present application relates generally to disc heat exchangers use in the rendering industry and, more particularly, to a rotating disc heat exchanger with wipers that extend between the discs.

### BACKGROUND

Disc heat exchangers are commonly used in the rendering industry for feathers, hair, blood, and meat processing byproducts. One embodiment is made from a plurality of rotating discs called a disc dryer. Disc dryers consist of a large enclosure/housing (shell) inside which a large shaft (rotor) rotates. Mounted on the shaft are multiple hollow discs that are heated buy an internal fluid. The material to be dried is loaded into the shell and the heated rotor rotates in the material, removing moisture from the material via evaporation.

The material being dried often clumps together and sticks to the surfaces between adjacent discs, reducing the efficiency of the heat transfer of the discs. Wiper systems are formed by stationary wipers that are mounted to the shell of the dryer and extend into the area between the discs of the rotor. As the clumped material on the rotor makes contact with the stationary wiper, the material is wiped away, restoring the efficiency of the drying process. Some of these clumps can be very tough to remove from the discs, which can result in damage to the wipers/wiper mounting structure. Damage to the wiper system can also be caused when a foreign body is inadvertently allowed to enter the system and becomes wedged between the discs of the rotor. To reduce the risk of this damage, a “break-away” style of wiper is often used. In this arrangement, the wiper is mounted on a pivot pin and is secured in place with a shear pin. The wiper performs normally until it encounters a clump of material or object that imparts an excessive force on the wiper, at which point the shear pin shears, allowing the wiper to pivot up and out of the material before damage can be done to the wiper and/or support structure.

This shear pin arrangement is generally effective. However, current designs connect the entirety of the wiper, including the shear pin, internally of the shell, per the exemplary prior art example of FIG. 1, where the wiper 2, shear pin 4, shell 6 and rotatable discs 8 are shown.

A sheared pin can go unnoticed until an internal inspection of the machine is performed since, with current designs, the entire wiper system is located within the shell of the dryer and out of sight of the operator. This also complicates replacement of the sheared pin due to the system’s location within the dryer. This inspection and shear pin replacement requires shutting down the dryer and often requires a confined-space permit as the worker must enter the confines of the dryer shell to replace the shear pin. Also, when a pin shears, the broken pieces fall into the material being dried and can damage other equipment further in the process. A second issue of this style of wiper system is that, in the event of a sheared pin, the wiper will ride up onto the material in the dryer. If the wiper comes into contact with a moving component of the rotor, such as a disc-mounted agitator paddle, or a foreign body, it can break free from its mounting system and cause damage to the dryer as it travels in the material being dried, often damaging other wipers in the dryer. This can result in significant repair costs and downtime for the customer. A third issue with this style of wiper system involves the placement of the wiper mounting brackets along the length of the shell. The brackets are typically welded internally to the shell structure, so their position along the length of the shell is fixed. This poses a problem because the disc-to-disc spacing on the rotor can vary slightly due to manufacturing irregularities of the rotor. This, in addition to the thermal expansion of the heated rotor can necessitate cutting the wiper mounting brackets free of the shell, repositioning and rewelding them to avoid the wipers making contact with components of the rotor and causing damage.

Accordingly, it would be desirable to provide a rotating disc heat exchanger that addresses one or more of the above issues.

### SUMMARY

In one aspect, a rotating disc heat exchanger includes a shell defining an internal space for heat treating material, and a plurality of discs located within the internal space and rotatable within the internal space during material processing. A plurality of wipers are provided, each wiper including a mount portion located at an external side of the shell outside of the internal space and a wiping portion that is located within the internal space and extends into a region between two side-by-side discs.

In another aspect, a rotating disc heat exchanger includes a shell defining an internal space for heat treating material via a plurality of rotatable discs located therein. A wiper includes a mount portion located outside of the internal space and a wiping portion that is located within the internal space. The shell includes a shell opening through which the at least one wiper extends. The mount portion includes a mount arrangement that is configured to enable: (i) adjustment of a position of the at least one wiper along a width of the shell opening; and/or (ii) removal and replacement of the at least one wiper from a location externally of the shell; and/or (iii) pivot of the at least one wiper about a pivot axis located externally of the shell, at least upon shear of a shear pin associated with the mount arrangement.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a prior art wiper mount arrangement;

FIGS. 2-3 show perspective views of a rotating disc heat exchanger;

FIG. 4 shows a side elevation of the heat exchanger;

FIG. 5-7 shows cross-sections of portions of the heat exchanger;

FIGS. 8 and 9 show cross-sections of a wiper mounting region of the heat exchanger with wiper guard/housing shown in FIG. 8 and wiper guard/housing not shown in FIG. 9;

FIGS. 10-11 show perspective views of isolated regions of the heat exchanger;

FIGS. 12-13 show perspective view of the isolated regions with wiper housing not shown;

FIGS. 14-18 show portions of the wiper mount arrangement;

FIGS. 19A-19B show an alternative wiper mount arrangement;

FIGS. 20A-20B show an alternative wiper mount arrangement;

FIGS. 21A-21B show an alternative wiper mount arrangement; and

FIGS. 22A-22B show an alternative wiper mount arrangement.

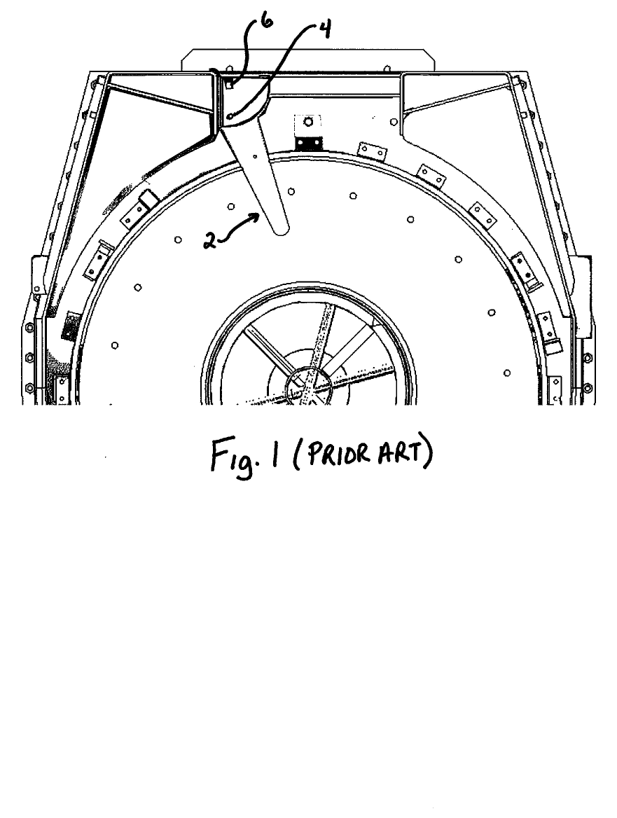

### DETAILED DESCRIPTION

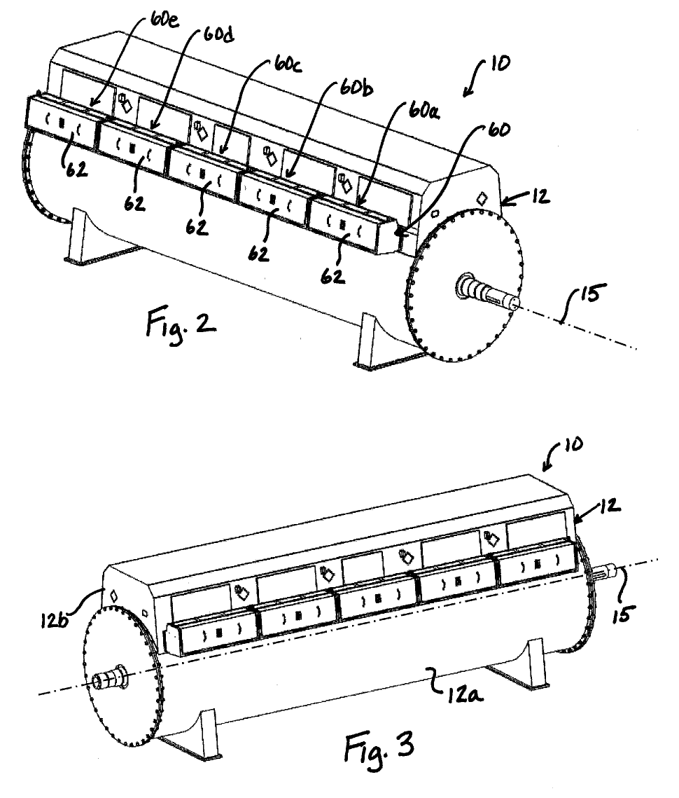

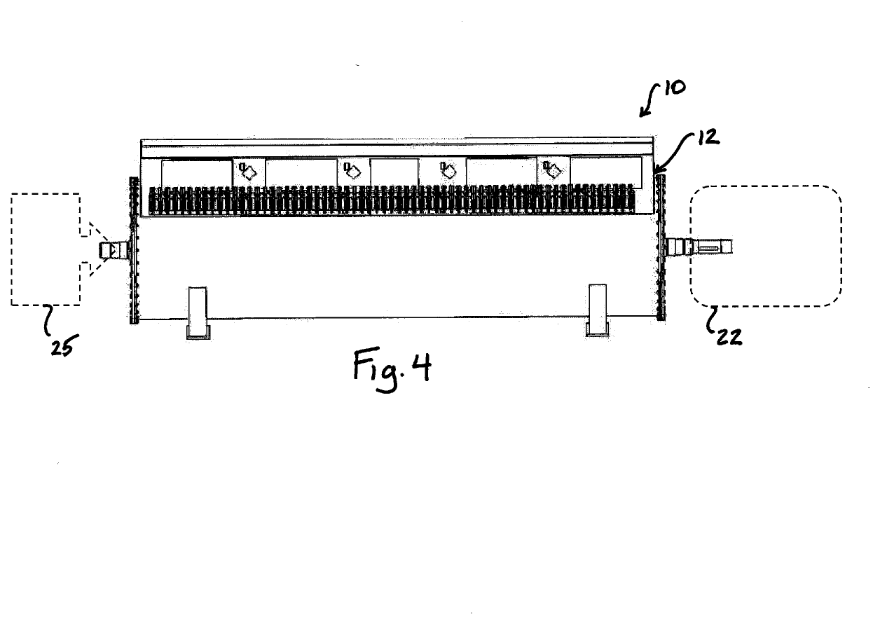

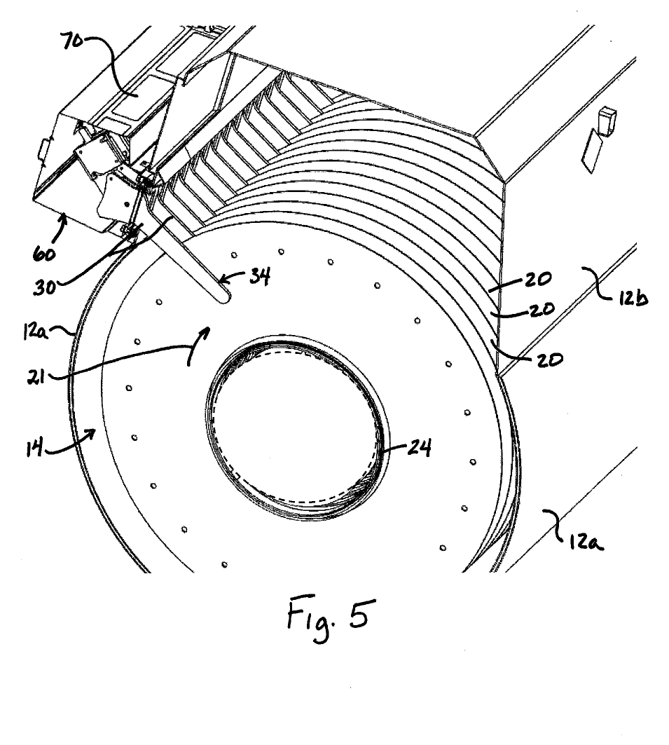

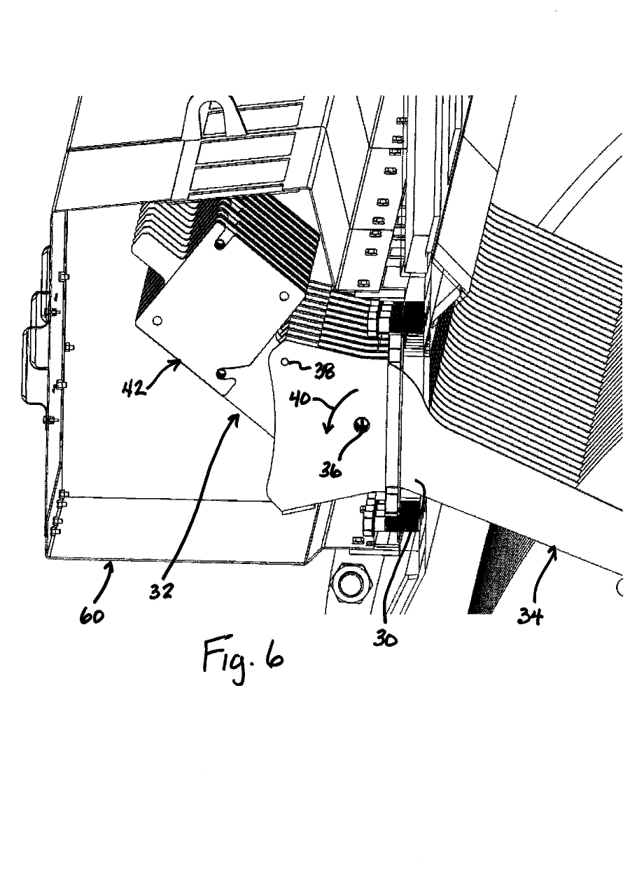

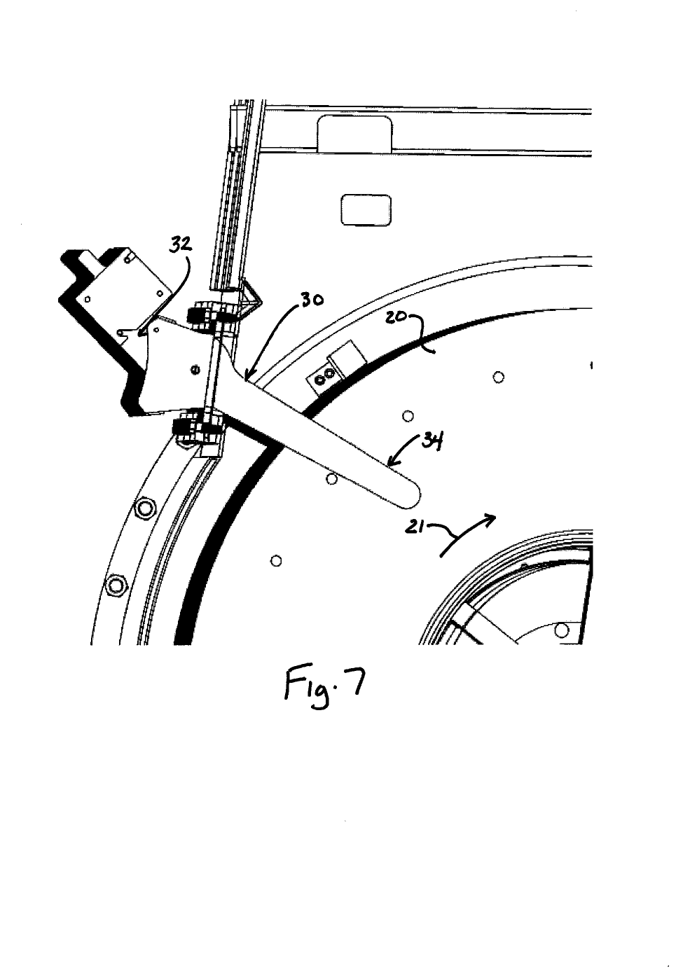

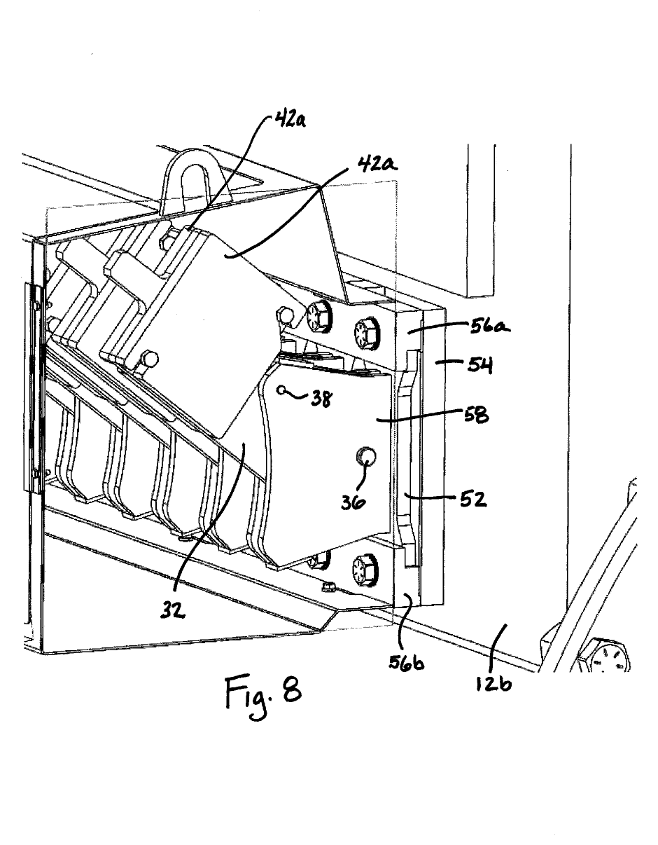

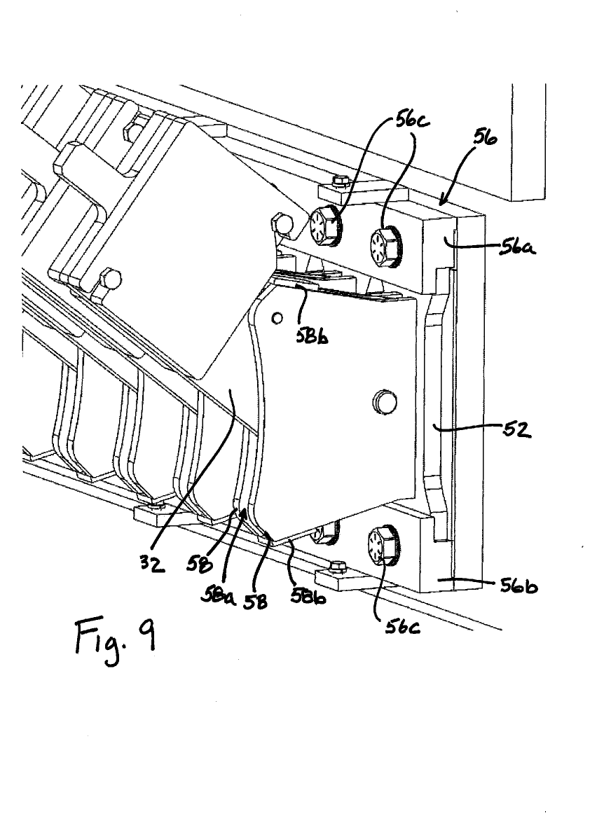

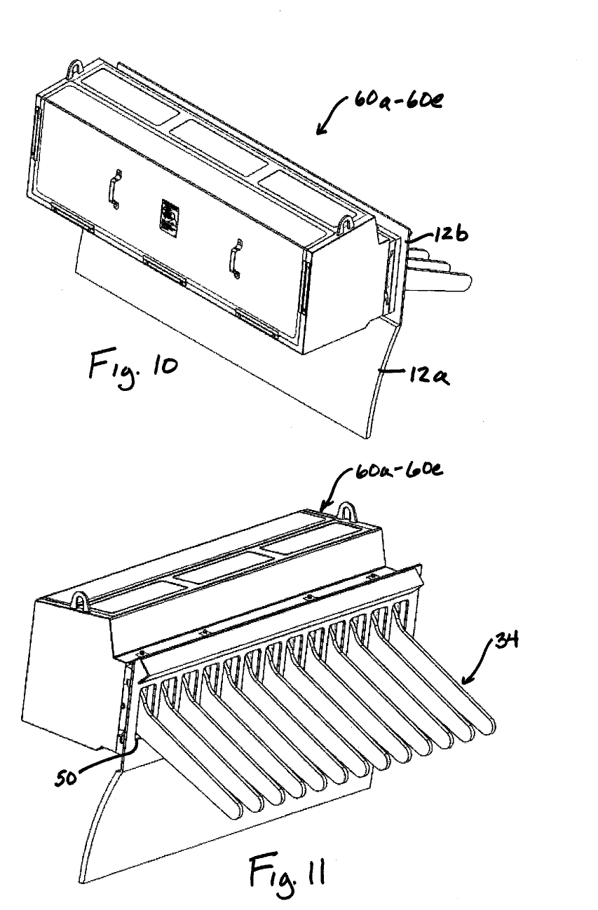

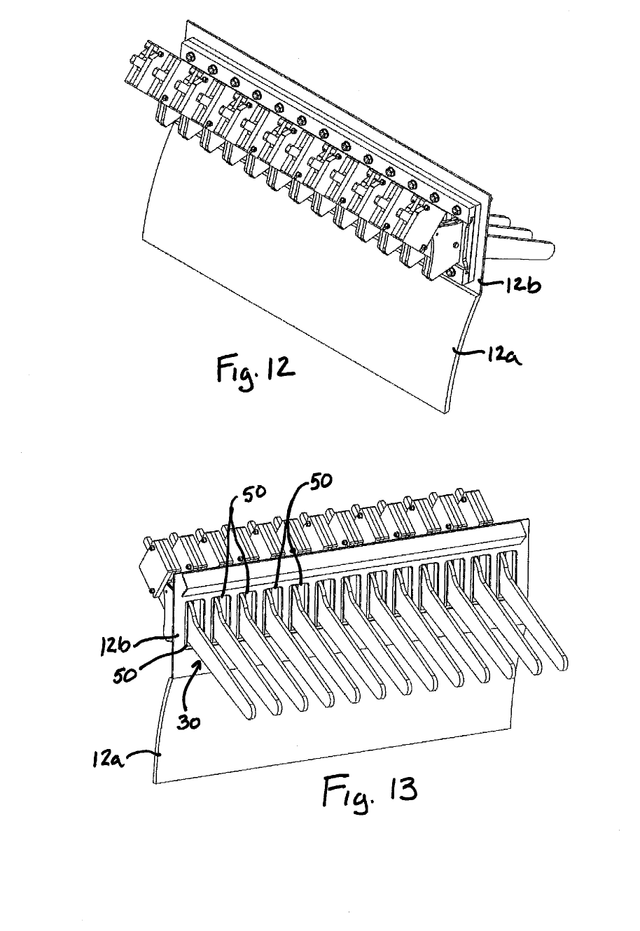

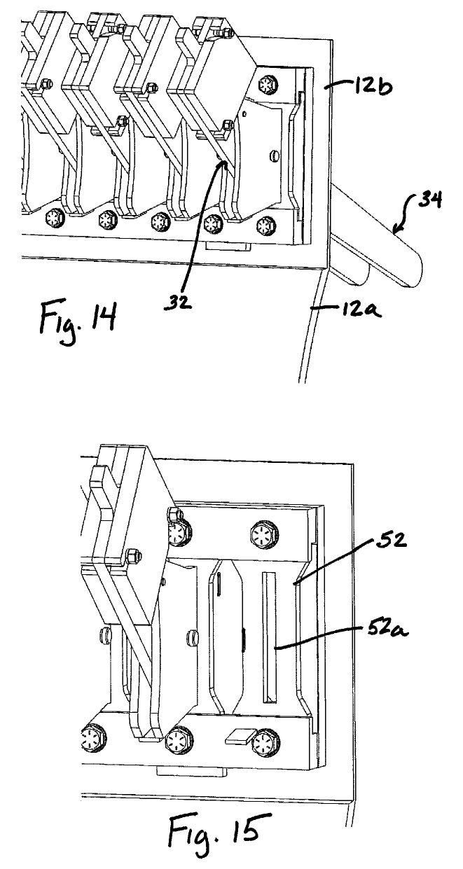

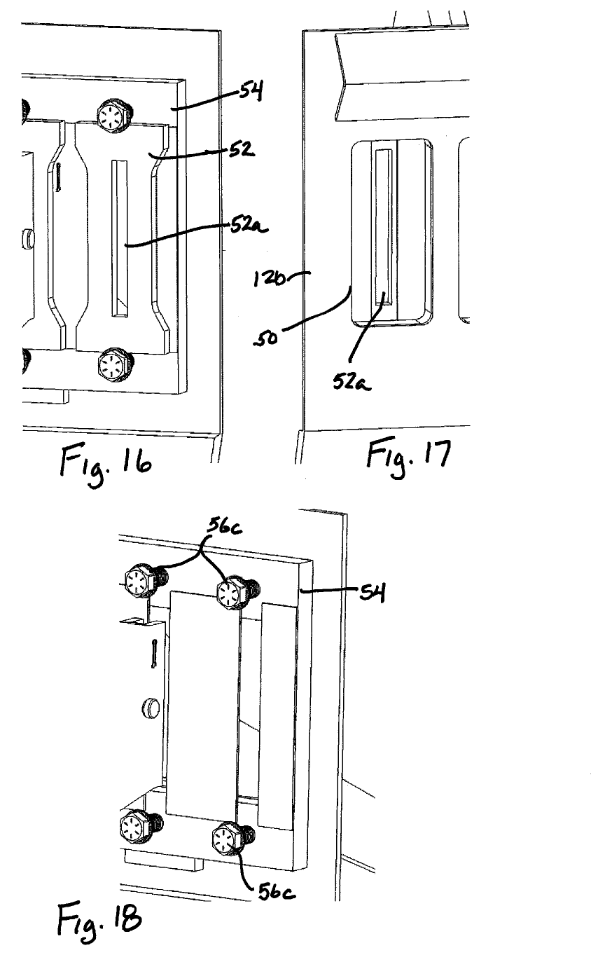

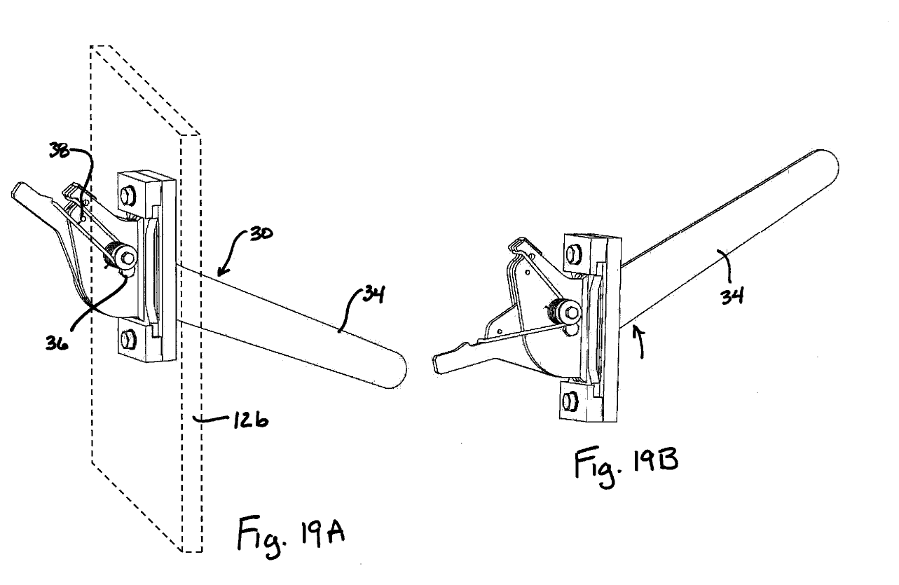

Referring to FIGS. 2-4, a rotating disc heat exchanger 10 includes a housing/shell 12 that defines an internal space 14 for heat treating material. The shell 12 is elongated along an axis 15 and includes a lower shell portion 12a that is arcuate in shape and an upper shell portion 12b that forms an upper vapor region within the internal space. In embodiments, the main shell or housing 12 has a long opening at the top. A vapor recovery hood over this opening may be provided to pull vapors away from material inside the shell. Material may be fed to the space 14 through the hood and to and through the top opening of the equipment, or through a connection added to the top of the equipment adjacent to the hood but in the same general area.

A plurality of discs 20 are located within the internal space 14 and are rotatable (e.g., in a direction 21 via a drive 22 that rotates a shaft 24). An arrangement is provided to deliver steam (e.g., from a steam source 25) into the discs to heat the discs, and a condensate removal system is also provided. This heating enables high temperature material processing. Alternative heat sources could be used, such as a flow of heated oil into and out of the discs 20.

The heat exchanger includes a plurality of wipers 30. Each wiper 30 includes a mount portion 32 located at an external side of the shell 12, outside of the internal space 14, and a wiping portion 34 that is located within the internal space and extends into a region between two side-by-side discs 20. The wipers 30 function to prevent or limit material build-up on or between the discs during material processing. Each mount portion includes a mount arrangement with a pivot pin 36 and shear pin 38 (or other trip mechanism), and both the pivot pin and the shear pin are located outside of the internal space 14. The shear pin 38 prevents rotation of the wiper about the pivot pin 36 until a force acting on the wiping portion 34 of the wiper causes the shear pin 38 to shear. Notably, when the shear pin does shear, the broken shear pin parts will remain outside of the internal space 14 so as to avoid any interference with material processing operations.

When the shear pin shears, the force of material acting on the wiping portion 34 of the wiper causes the wiper to rotate in a direction 40 about the pivot pin 36 from its normal operating position into a non-operating position in which the wiping portion 34 is located externally of the region between the two side-by-side discs 20. Each wiper mount portion 32 also carries a counterweight 42, which here is formed by a pair of plates 42a fastened on respective sides of the wiper. The counterweight 42 is sufficient to keep the wiper 30 in the non-operating position. This counterweight arrangement is beneficial because is prevents the wiper from repeatedly bouncing back and forth between the operating position and non-operating position.

The shell 12 includes a plurality of shell openings 50 therein and each wiper 30 extends through a respective one of the shell openings. The mount arrangement of each wiper is configured to enable a lateral position of the wiper 30 within the shell opening 50 to be adjusted in order to locate the wiping portion of the wiper at a desired position between two side-by-side discs. Here, the wiper mount arrangement includes a wiper guide plate 52 with a through slot 52a therein and through which the wipers extend. The wiper guide plates 52 seat against a mount plate 54 that is fixed (e.g., welded) to the exterior surface of the shell 12. A clamp assembly 56 holds the wiper guide plates 52 in operating positions and, upon release or loosening of the clamp assembly, the operating positions of the wiper guide plates 52 can be shifted laterally along the shell openings 50. Here the clamp assembly 56 includes an upper clamping wiper 56a and a lower clamping wiper 56b, each of which includes an undercut that captures the respective upper and lower ends of the wiper guide plates 52. A series of bolts 56c can be tightened to clamp the clamping wipers against the mount plate 54, and can be loosened to allow for the position adjustment. The clamping wipers 56a, 56b can also be removed entirely to allow the wipers 30 to be removed (e.g., for replacement) as desired. Thus, the arrangement provides the advantage of enabling wiper replacement from a location externally of the shell.

Multiple pairs of cooperating upper and lower clamping wipers 56a, 56b may be provided sequentially along the length of the shell, with each pair utilized to secure multiple wipers 30 in operating positions. This configuration enables selective wiper adjustment and/or replacement while allowing many of the wipers to remain fixed in their operating positions.

Each wiper guide plate 52 includes a respective pair of mount brackets 58 extending outwardly therefrom to define a slot 58a in which part of the wiper is received. The mount brackets 58 may, for example, be welded to the wiper guide plate 52. The mount brackets include upper and lower connections 58b for stability of plate position and orientation. The wiper pivot pin 36 and the wiper shear pin 38 are connected to the mount brackets 58. End portions of the wipers extend outward beyond the slots 58a to receive the counterweight plates 42a.

A wiper guard/housing 60 is mounted at an external side of the shell 12 to enclose the mount portions of the wipers. The wiper guard/housing 60 includes one or more panels or doors 62 movable (e.g., via hinged connections or by being completely separable) between an enclosing position that prevents access to the mount portions of the wipers and an access position that enables access to the mount portions of the wipers. In embodiments, each panel or door 62 requires a tool or key in order to enable movement from the enclosing position to the access position and/or the rotating disc heat exchanger further includes an interlock arrangement (e.g., sensor(s) linked to a machine control) for preventing rotation of the discs 20 when any panel or door 62 is moved out of its enclosing position.

Hear, the wiper guard/housing includes multiple adjacent sections 60a-60e running along the length of the shell. Each section 60a-60e may include a respective mount plate 54 therein, with a corresponding group of clamping wipers 56a, 56b, set of wiper guide plates 52, and corresponding wipers 30 therein.

Regions 70 (see FIG. 5) in the upper sections of the wiper access housing may be comprised of expanded metal for enabling viewing positions of the wipers without requiring removal of the guard.

In embodiments, existing in-field rotary disc heat exchanges can be modified or retrofit to include the wiper system as described above.

It is to be clearly understood that the above description is intended by way of illustration and example only and is not intended to be taken by way of limitation. Variations are possible.

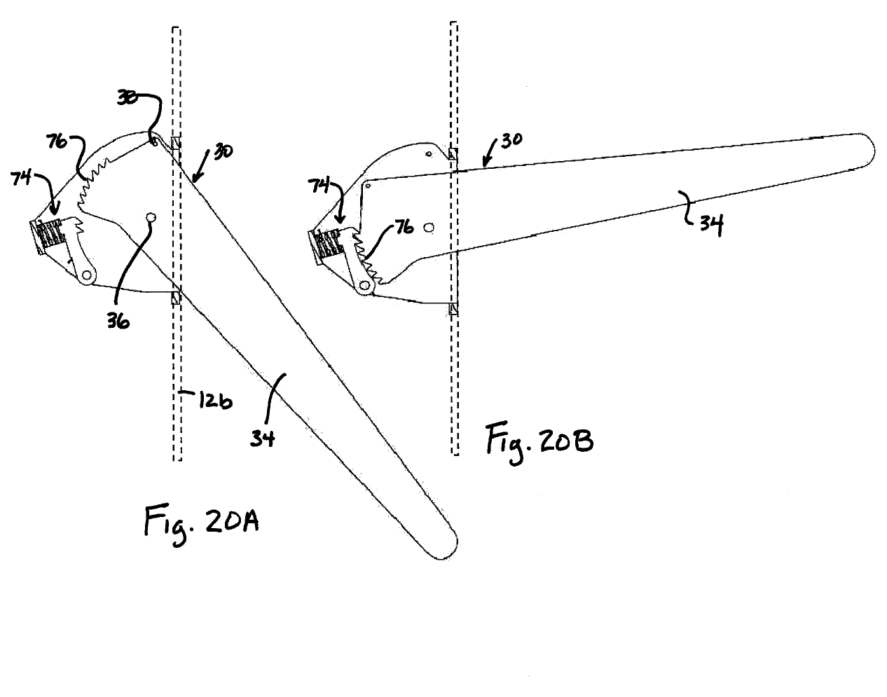

For example, in alternative embodiments, rather than utilizing a counterweight system, springs could be used. FIGS. 19A-19B show such an embodiment, where in the case of shear of the shear pin 38, a torsion spring 72 lifts the wiping portion 34 of the wiper 30 upward. FIGS. 20A and 20B show an embodiment in which, the case of shear of the shear pin 38, when the material forces the wiping portion 34 of the wiper bar 30 upward, a spring-loaded ratchet pawl 74 engages with ratchet teeth 76 at the external end of the wiper 30 to hold wiping portion 34 up.

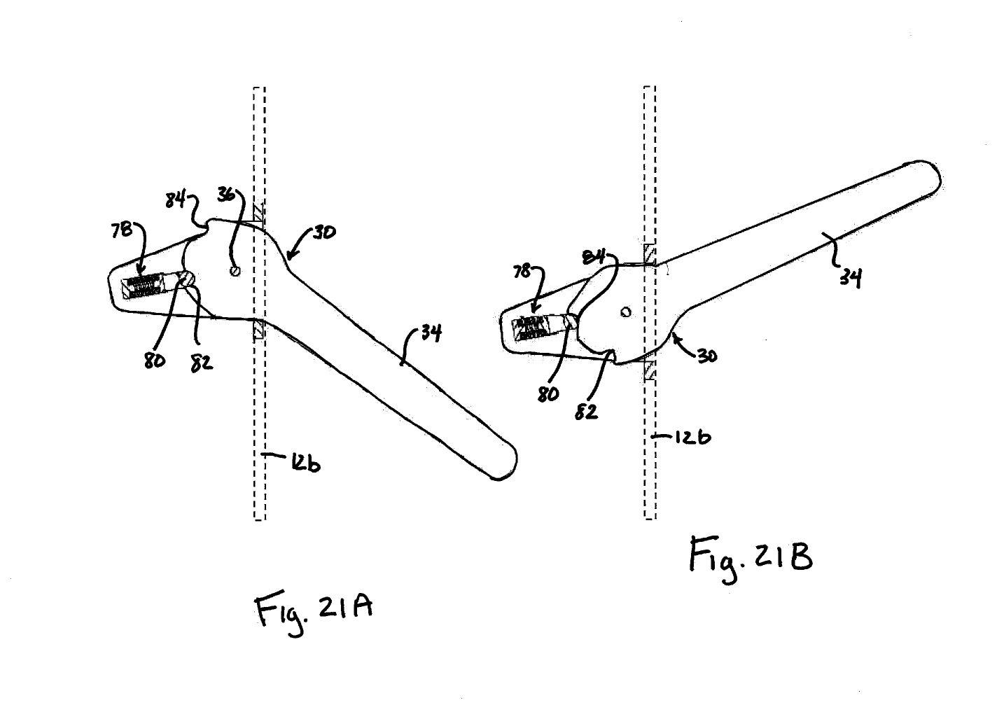

While the foregoing embodiments employ wiper bars with a shear pin trip mechanism, other arrangements are possible. In this regard, FIGS. 21A-21B shows an embodiment in which the trip mechanism takes the form of a compression spring 78 with a spring follower 80 that seats into a groove/recess 82 of the external portion of the wiper 30 to hold the wiper in the operating position of FIG. 21A until an obstruction operating on the wiping portion 34 causes enough torque on the wiper to overcome the force of the compression spring. The wiper then pivots, placing the wiping portion 34 up out of the material zone (per FIG. 21B) and the spring follower engages into another groove/recess 84 to hold the arm in the tripped position (FIG. 21B).

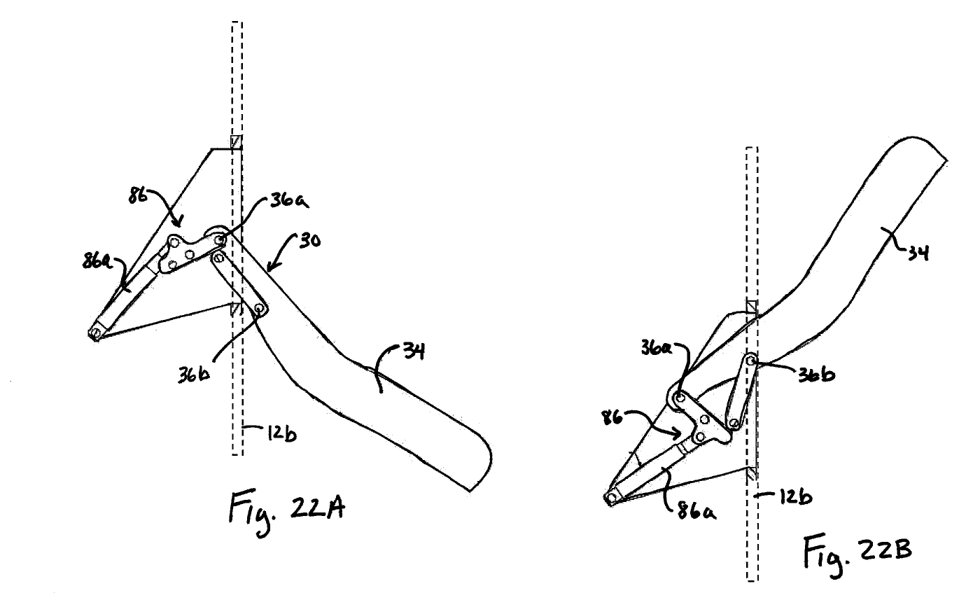

While the foregoing embodiments all employ wipers that pivot about a stationary pivot axis (defined by the pivot pins 36), other arrangements are possible. FIGS. 22A-22B depict an embodiment in which a gas spring-loaded over-center trip mechanism 86 with multiple linkages is utilized. The gas spring 86a holds the wiper in the operating position (FIG. 22A) until an obstruction operating on the wiping portion 34 causes enough torque on the wiper to overcome the force of the gas spring and pushes the wiping portion 34 upward to the tripped position (FIG. 22B). The over-center arrangement of the linkages then enables the gas spring 86a to hold the wiper in the tripped position. In this arrangement, the wiper 30 is pivotable about multiple pivot pins 36a 36b, where the pivot axes of such pivot pins move as as the multiple linkages change position.

Still other variations are possible.

1. A rotating disc heat exchanger, comprising:
a shell defining an internal space for heat treating material;
a plurality of discs located within the internal space and rotatable within the internal space during material processing;
a plurality of wipers, each wiper including a mount portion located at an external side of the shell outside of the internal space and a wiping portion that is located within the internal space and extends into a region between two side-by-side discs.

2. The rotating disc heat exchanger of claim 1, wherein each mount portion includes a mount arrangement with a pivot pin and a trip mechanism, both the pivot pin and the trip mechanism located outside of the internal space.

3. The rotating disc heat exchanger of claim 2, wherein the trip mechanism prevents rotation of the wiper about the pivot pin until a force acting on the wiping portion of the wiper causes the trip mechanism to trip.

4. The rotating disc heat exchanger of claim 3, wherein each mount portion carries a counterweight such that, when the trip mechanism trips, the wiper rotates to and stays in a position in which the wiping portion is located externally of the region between the two side-by-side discs.

5. The rotating disc heat exchanger of claim 2, wherein the trip mechanism is one of (i) a shear pin that trips by shearing, (ii) a spring-loaded device or (iii) an over-center gas spring mechanism.

6. The rotating disc heat exchanger of claim 2, wherein the shell includes a plurality of shell openings therein and each wiper extends through a respective one of the shell openings.

7. The rotating disc heat exchanger of claim 6, wherein each mount arrangement is configured to enable a lateral position of the wiper within the shell opening to be adjusted in order to locate the wiping portion at a desired location between the two side-by-side discs.

8. The rotating disc heat exchanger of claim 7, wherein:
each mount arrangement comprises a wiper guide plate with a through slot therein through which the wiper extends;
a clamp assembly holds the wiper guide plate in an operating position and, upon release or loosening of the clamp assembly, the operating position of the wiper guide plate can be shifted laterally along the shell opening.

9. The rotating disc heat exchanger of claim 8, wherein the clamp assembly holds multiple wiper guide plates in respective operating positions.

10. The rotating disc heat exchanger of claim 2, wherein each mount arrangement is configured to enable removal of the wiper from a location externally of the internal space so as to permit replacement of the wiper from the location externally of the internal space.

11. The rotating disc heat exchanger of claim 1, further comprising an wiper access housing mounted at an external side of the shell to enclose the mount portions of the wipers.

12. The rotating disc heat exchanger of claim 11, wherein the wiper access housing includes a panel or door movable between an enclosing position that prevents access to the mount portions of the wipers and an access position that enables access to the mount portions of the wipers.

13. The rotating disc heat exchanger of claim 12, wherein:
the panel or door requires a tool or key in order to enable movement from the enclosing position to the access position;
and/or
the rotating disc heat exchanger further includes an interlock arrangement for preventing rotating of the discs when the panel or door is moved out of the enclosing position.

14. A rotating disc heat exchanger, comprising:
a shell defining an internal space for heat treating material;
a plurality of discs located within the internal space and rotatable within the internal space during heat treating of material, wherein the discs are configured to be heated internally by a heated fluid source;
at least one wiper including a mount portion located at an external side of the shell outside of the internal space and a wiping portion that is located within the internal space and extends into a region between two side-by-side discs;
wherein the shell includes a shell opening through which the at least one wiper extends;
wherein the mount portion includes a mount arrangement that is configured to enable at least one of:
(i) adjustment of a position of the at least one wiper along a width of the shell opening; or
(ii) removal and replacement of the at least one wiper from a location externally of the shell; or
(iii) pivot of the at least one wiper about a pivot axis located externally of the shell, at least upon shear of a shear pin associated with the mount arrangement.

15. The rotating disc heat exchanger of claim 14, wherein the mount arrangement is configured to enable both:
(i) adjustment of the position of the at least one wiper along the width of the shell opening; and
(ii) removal and replacement of the at least one wiper from the location externally of the shell.

16. The rotating disc heat exchanger of claim 14, wherein the mount arrangement is configured to enable both:
(ii) removal and replacement of the at least one wiper from the location externally of the shell; and
(iii) pivot of the at least one wiper about the pivot axis located externally of the shell, at least upon shear of the shear pin associated with the mount arrangement.

17. The rotating disc heat exchanger of claim 14, wherein the mount arrangement is configured to enable all of:
(i) adjustment of the position of the at least one wiper along the width of the shell opening;
(ii) removal and replacement of the at least one wiper from the location externally of the shell; and
(iii) pivot of the at least one wiper about the pivot axis located externally of the shell, at least upon shear of the shear pin associated with the mount arrangement.
